(19) United States
(12) Patent Application Publication
(10) Pub. No.: US 2004/0104942 A1
(43) Pub. Date: Jun. 3, 2004

(54) Display and operating device, in particular a touch panel

(75) Inventor: Stefan Weigel, Kalchreuth (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AG

(21) Appl. No.: 10/630,828

(22) Filed: Jul. 31, 2003

Related U.S. Application Data
(63) Continuation of application No. PCT/DE02/00150, filed on Jan. 18, 2002.

(30) Foreign Application Priority Data
Jan. 31, 2001 (DE) 201 017 68.7

(51) Int. Cl. G09G 5/00

(52) U.S. Cl. 345/773

(57) ABSTRACT

A display and operating device (A) that has a touch-sensitive display unit (B) for outputting display objects (AZ, K) and has a processing unit such as a graphics card (G). This processing unit has a first component that processes display data of a first display object that represents a technical process and a second display object that simulates an on-screen keyboard (K) with keyboard elements (T), and has a second component that superimposes the first and second display data in such a manner that the on-screen keyboard and the first display object appear transparent on the touch-sensitive display unit. A third component of the processing unit detects an input position (P) on the touch-sensitive display unit, while a fourth component associates the detected input position with a keyboard element and initiates an action associated with this keyboard element. The entire surface of the touch-sensitive display unit is thereby rendered available for the user to input data via the transparent on-screen keyboard without thereby adversely affecting the visibility of the first display data.

This is a Continuation of International Application PCT/DE02/00150, with an international filing date of Jan. 18, 2002, which was published under PCT Article 21(2) in German, and the disclosure of which is incorporated into this application by reference.

### FIELD OF AND BACKGROUND OF THE INVENTION

The invention relates to an industrial display and operating device with a touch-sensitive display unit suitable for both the visual output of data or graphics and the manual input of data. For this purpose the user can use, for example, a finger or a stylus-type input aid to touch the surface of the display unit at the desired location and thereby initiate other actions, e.g., the acceptance of a character that has been entered. Such display and operating devices are preferred, for instance, in industrial production plants and are also referred to as operator interfaces. These display and operating devices are described, for instance, in Siemens Aktiengesellschaft Catalogue ST80•2000 entitled “Operating and Monitoring Products/Systems” (Order No. E86060-K4680-A111-A7).

It is necessary to enter alphanumeric characters, i.e., entering letters, symbols and numbers, in order to document, e.g., the result of an automation process or to input, e.g., new parameters for a process to be modified. To this end a user can use, for instance, a separate keyboard of the operator interface to initiate changes in process control by making entries in a data field provided for this purpose.

In another embodiment of the operator interface, so-called touch panels are used. These touch panels have a touch-sensitive display unit with a touch screen. The touch screen is used to select input fields or buttons, which are output on the display unit and can be activated using, e.g., a finger. The selectable input fields can be arranged over a relatively large area to enable fast, accurate and easy operation.

To enter alphanumeric characters, it is also possible, for example, to use a graphic replica of a keyboard on the touch-sensitive display unit. Such a replica is also referred to as an on-screen keyboard.

This has the drawback, however, that a portion of the display area is occupied by the on-screen keyboard, so that objects located “underneath” the keyboard are hidden. As a result, the user has only a limited display area remaining and available for any feedback to the entered data. In particular when the device is used in an industrial environment, a further drawback for the user is that, for example, display data of display objects, e.g., a graph of a current process, cannot be viewed in full because they are covered by the on-screen keyboard. As a compromise, for instance, half of the available display area can be selected for the on-screen keyboard. In this case, the user can shift the on-screen keyboard to a display area with less important display objects.

U.S. Pat. No. 6,121,960 discloses “touch screen systems and methods” and is incorporated into the present application by reference. The touch screen disclosed there is used for the simultaneous, i.e., superimposed, output of a background image, e.g., a landscape or an output image generated by an application program, and a virtual keyboard. U.S. Pat. No. 6,121,960 also describes methods to control the pixels of the touch screen for the superimposed display of the background image and the virtual keyboard. This is to produce cross-fading and mixing effects that influence the superimposed output of the background image and the virtual keyboard.

### OBJECTS OF THE INVENTION

An object of the invention is to provide an operator panel with a touch-sensitive display unit for manual data input, which is suitable in particular for operating and monitoring industrial processes and the dynamic changes that occur in such processes, especially the changes in technical measured values.

### SUMMARY OF THE INVENTION

According to one formulation, this and other objects are attained by an operator interface equipped with a touch-sensitive display unit for outputting display objects and a processing unit, including: a) a first component to process at least: a1) industrial display data of a first (AZ) of the display objects to represent a technical process and a2) display data of a second of the display objects (K) to simulate an on-screen keyboard (K) having keyboard elements (T), b) a second component to superimpose the display data of the first and the second display objects such that the on-screen keyboard (K) and the first display object (AZ) appear mutually transparent on the touch-sensitive display unit, c) a third component to detect an input position (P) on the touch-sensitive display unit, and d) a fourth component to associate the detected input position (P) with one of the keyboard elements (T) of the on-screen keyboard (K) and to initiate an action associated with the keyboard element (T). The display data of the first and second display objects are coupled such that using a keyboard element (T) of the second display object (K) initiates an action influencing the industrial display data of the first display object (AZ) and causes effects of the action to be displayed directly in the first display object (AZ).

### BRIEF DESCRIPTION OF THE DRAWINGS

The invention will now be described in greater detail with reference to the figures in which:

FIG. 1 is a display and operating device with an exemplary on-screen keyboard for manual data input on a touch-sensitive display unit,

FIG. 2 is an exemplary configuration of the touch-sensitive display unit with an exemplary input aid,

FIG. 3 shows an operator panel designed for stationary use as an example of a display and operating device, with processing according to the invention of the display data of the on-screen keyboard and the exemplary industrial display data, and

FIG. 4 shows an operator panel designed for mobile use as a further example of an industrial display and operating device with an exemplary input aid.

### DETAILED DESCRIPTION OF THE PREFERRED EMBODIMENTS

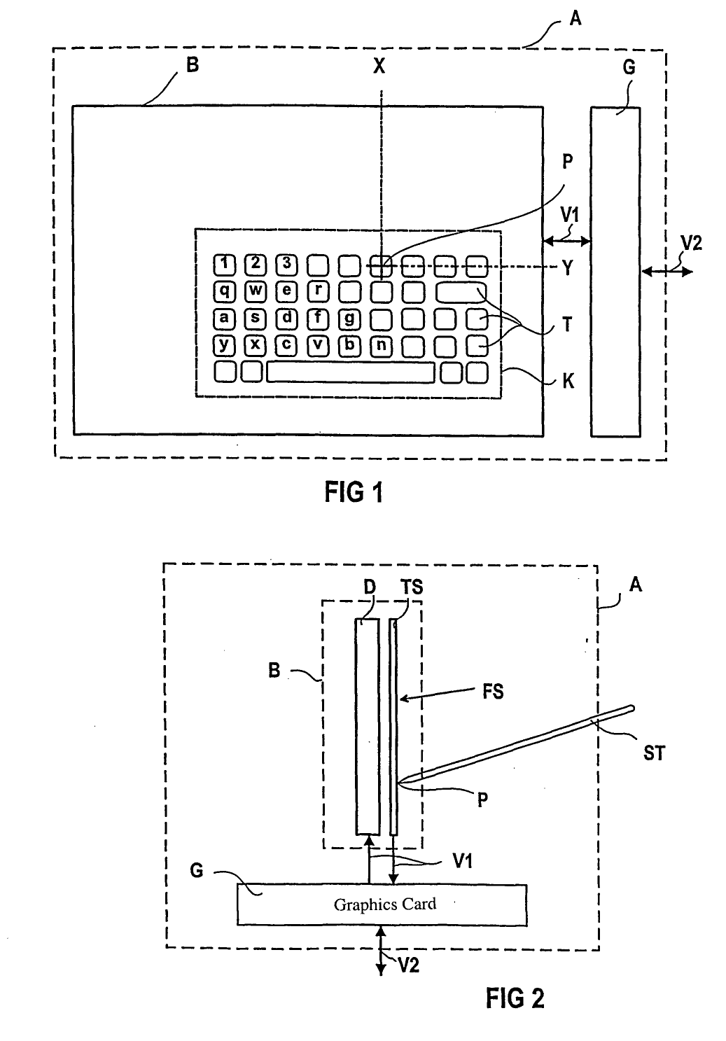

A display and operating device A will now be described with reference to the example depicted in FIG. 1, which shows an exemplary on-screen keyboard K for manual data entry. The display and operating unit A has a touch-sensitive display unit B and a processing unit G, e.g., a graphics card. This processing unit is connected with the touch-sensitive display unit B via a connection V1 for exchanging, in particular, display data. The processing unit G, using the connection V2, can furthermore communicate with a processing unit used for further processing (not shown).

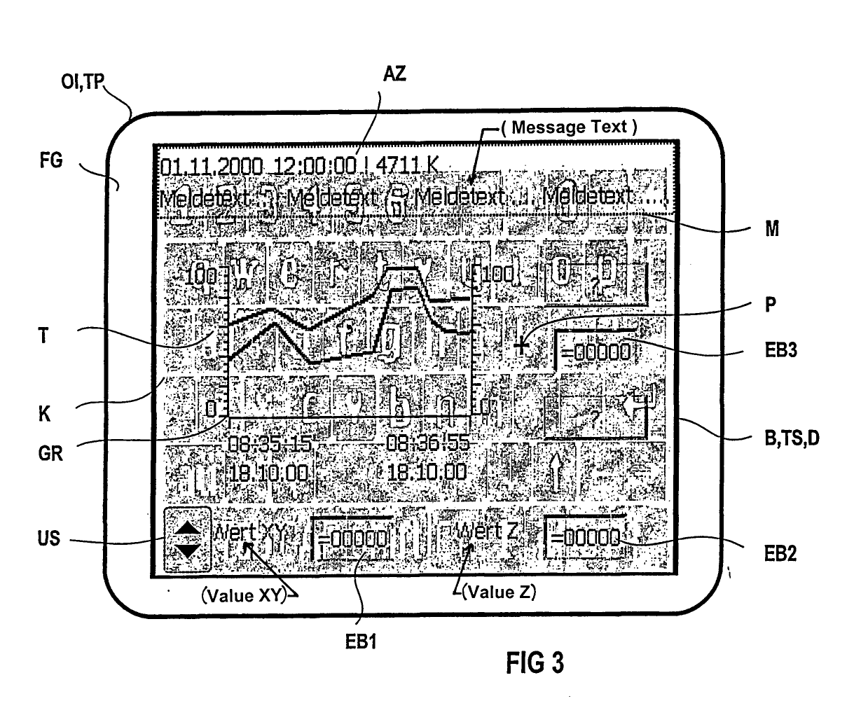

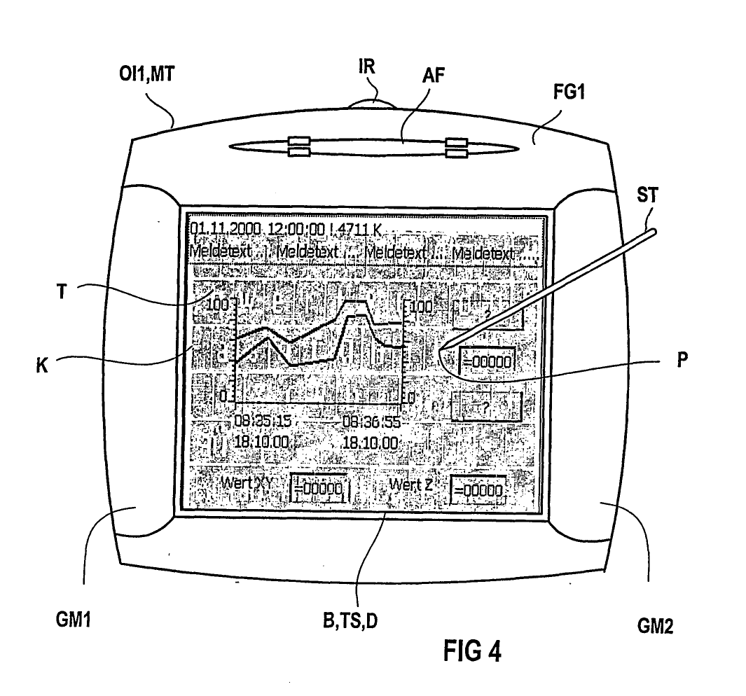

The display area of the touch-sensitive display unit B shows an exemplary on-screen keyboard K for entering alphanumeric characters using the corresponding keyboard elements T, e.g., keys. In addition, a plurality of display objects may be shown, e.g., Windows application screens, data input fields, icons, images or graphics. Icons are small symbolic representations of an executable application or a document. The aforementioned display objects AZ can be arranged in many different ways, e.g., overlapping or side-by-side. For reasons of clarity, these objects are not depicted in FIG. 1. They will be described in greater detail with reference to FIGS. 3 and 4. An input position P on the touch-sensitive display unit B can be determined via a connection V1, for instance, by the processing unit C, which is shown by way of example in FIG. 1, or separately by another evaluation unit. The coordinates X, Y associated with the input position P make it possible to relate the position to a key T, which appears at the same location. Through virtual pressing of the associated key T, an action is initiated, e.g., the acceptance of the characters entered in this manner.

FIG. 2 shows, by way of example, a configuration of the above-described touch-sensitive display unit B, in a side view, with an exemplary input aid ST. The unit includes a display, e.g., an LCD display D, and a touch-sensitive flat element, e.g., a touch screen TS, mounted in front of the display. Data is entered by touching the touch screen TS on the front side FS of the touch-sensitive display unit B, using a finger or input aid, e.g., a stylus ST. The example depicted in FIG. 2 further shows, on the one hand, that the exemplary graphics card G transmits the display data to the display D via the connection V1 and, on the other hand, receives the position data from the touch screen TS, to determine the input position P.

FIG. 3 is a top view of an operator interface OI, embodied as a touch panel TP and designed, e.g., for stationary use. This touch panel, which is an example of a display and operating device A, illustrates the processing according to the invention of the display data of the on-screen keyboard K and of the exemplary industrial display data. To protect the touch-sensitive display unit B from mechanical damage, it is accommodated, for example, in a flat housing FG Touch panels TP of the above-described type are frequently mounted on the front of control cabinets or control devices. This makes it easy for a user, e.g., an operator or a quality assurance person, to view and monitor the current status or the displayed process. Such stationary touch panels TP are often also integral components of instrument and control panels for the continuous monitoring and control of, for instance, a production process.

FIG. 3, also shows, by way of example, industrial display data of various display objects AZ, e.g., a message window M, three data input fields EB1 to EB3 and a graph GR. The graph GR can represent, in particular, a dynamic process image. The exemplary message window M in the upper area of the display D includes a frame for displaying a pertinent message text, here, e.g., a fault event with the associated date and time. Furthermore, a graph GR is shown, which represents, for example, the time characteristic of e.g., two measured values of an industrial process. Also visible are various data input fields EB1 to EB3 whose values can be changed, e.g., to change parameters of the technical process.

According to the invention, in the example of FIG. 3, an on-screen keyboard K and the above-described display objects AZ are output over the entire display area of the touch-sensitive display unit B in such a way that they appear transparent. Thus, the above-described display objects AZ continue to be visible and are not covered by the on-screen keyboard K. This makes it advantageously possible to use the keyboard elements T of the on-screen keyboard K which is superimposed in this manner to input letters, symbols and numbers as well as control characters, e.g., the return key. Moreover, any effects of the data entered in a previously selected data input field EB1 to EB3 can be observed immediately.

In the example of FIG. 3, a cross identifies the current input position P. Using a finger or, for instance, a stylus-type input aid, the key T associated with the letter “k” can be selected on the on-screen keyboard K by “pressing” it. Furthermore, changes in other display objects AZ can advantageously be monitored directly during data entry, e.g., changes in the exemplary graph GR. If the display of the on-screen keyboard K were not transparent, these changes would initially remain hidden, i.e., they could not be observed immediately.

Thus the user can advantageously continue to monitor a plant, for instance, and if necessary can take appropriate actions if the plant enters a non-optimal state.

According to the invention, the means for processing the display data of the display objects AZ and the on-screen keyboard K are preferably software routines. A microprocessor of a PC, for example, can be used to execute these software routines, or preferably a fast graphics chip that is optimized for graphic displays. For this purpose, the software routines can be integrated in the graphics chip as a microprogram to increase the processing speed.

Furthermore, according to the invention, a separate toggle element US, e.g., a toggle key, is preferably displayed on the on-screen keyboard K as an additional display object AZ, to provide a toggle function. Advantageously, this makes it possible, depending on the state of this detected toggle key US, to assign the input position P either to the first display objects AZ or to the on-screen keyboard K. As a result, a specific selection can be easily made, especially when the display objects generated by a commercial operating system, e.g., Windows, are shown overlapped. The current toggle function of the toggle key US can be made identifiable, for example, by overlaying the corresponding display data in such a manner that the on-screen keyboard K, for example, appears more obvious during data entry.

Furthermore, according to another embodiment of the invention, the user is given the option in the overlay to adjust the display density ratio of the display data between the display objects AZ and the on-screen keyboard K. Advantageously this makes it possible, e.g., depending on the user's familiarity with the on-screen keyboard K, to fade in the keyboard to a greater or lesser extent. A user who is skilled in using the on-screen keyboard K according to the invention will fade in the keyboard to a lesser degree because he is familiar with the position of the individual keys T. As a result, e.g., for monitoring tasks, the user can advantageously make the display data of the display objects AZ even more clearly distinguishable.

FIG. 4, in a further example of a display and operating device A, shows a mobile component MT designed for mobile use, with exemplary input aid ST. This can be a portable or handheld computer. The aforementioned mobile components MT can be connected with a master computer, e.g., via radio, to remote control a process. The device shown has, for example, a flat housing FG1 with a recessed grip GM1 for the left hand and a recessed grip GM2 for the right hand of an operator. Thus, the operator can comfortably transport the device using one or both hands. Approximately in the center of the flat housing FG1 a touch-sensitive display unit B is arranged which displays the same image as that depicted in FIG. 3 and the same on-screen keyboard K according to the invention. The keyboard has a smaller format for mobile use. Because more than one key T can be pressed when the on-screen keyboard K in the example of FIG. 4 is touched with a finger, an input aid, e.g., a stylus, may be used to prevent keying errors. The input position P is detected when the stylus tip of the input aid ST touches the touch screen TS. In the example of FIG. 4, the key T with the letter “k” is selected on the on-screen keyboard K. In the edge area of the flat housing FG1 located above the touch-sensitive display unit B, a holder AF is provided for the stylus ST. Other elements may of course also be arranged in the housing, for instance removable energy storage means, e.g., batteries, and data interfaces, e.g., an infrared data interface IR. For the sake of clarity these elements are either not depicted or indicated only generally in the embodiment of FIG. 4.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. Operator interface equipped with a touch-sensitive display unit for outputting display objects and a processing unit, comprising:
a) first means to process at least:
a1) industrial display data of a first (AZ) of the display objects to represent a technical process and
a2) display data of a second of the display objects (K) to simulate an on-screen keyboard (K) having keyboard elements (T),
b) second means to superimpose the display data of the first and the second display objects such that the on-screen keyboard (K) and the first display object (AZ) appear mutually transparent on the touch-sensitive display unit,
c) third means to detect an input position (P) on the touch-sensitive display unit, and
d) fourth means to associate the detected input position (P) with one of the keyboard elements (T) of the on-screen keyboard (K) and to initiate an action associated with the keyboard element (T),
wherein the display data of the first and second display objects are coupled such that using a keyboard element (T) of the second display object (K) initiates an action influencing the industrial display data of the first display object (AZ) and causes effects of the action to be displayed directly in the first display object (AZ).

2. Operator interface as claimed in claim 1, wherein the industrial display data of the first display object (AZ) comprise a message window (M) of the technical process.

3. Operator interface as claimed in claim 1, wherein the industrial display data of the first display object (AZ) include a graph (GR) to display the time characteristic of a measured value of the technical process.

4. Operator interface as claimed in claim 1, wherein the industrial display data of the first display object (AZ) comprise a data input field (EB1, EB2, EB3) to specify a parameter value of the technical process.

5. Operator interface as claimed in claim 1, wherein the processing unit comprises:
a) fifth means to process display data of a third (US) of the display objects to simulate at least one toggle element (US), and
b) sixth means to associate the detected input position (P) with the at least one toggle element (US),
wherein the input position (P) on the touch-sensitive display unit (B) is associated either with the at least one first display object (AZ) or with the second display object (K), in accordance with a toggle state of the toggle element.

6. Operator interface as claimed in claim 1, wherein the touch-sensitive display unit comprises a touch panel.

7. Operator interface as claimed in claim 1, wherein the processing unit comprises fifth means to adjust a ratio of respective output densities of the superimposed display data of the first and the second display objects.

8. Operator interface as claimed in claim 1, wherein the first and second means comprise software routines.

9. Operator interface as claimed in claim 8, wherein the software routines comprise at least one microprogram integrated in a microprocessor.

10. An apparatus comprising:
a touch-sensitive display unit displaying display objects and detecting inputs from a user; and
a processor comprising:
a first module that processes display data of a first display object that provides information regarding a technical process and display data of a second display object that simulates an on-screen keyboard having keyboard elements (T),
a second module that superimposes the first and the second display objects on the display unit such that the on-screen keyboard and the first display object appear overlapping and mutually transparent on the touch-sensitive display unit, and
a third module that processes detected inputs from the touch-sensitive display and outputs updated display data to the first module to update the first display object while superimposed with the second display object.

11. The apparatus according to claim 10, further comprising a fourth module that regulates a display density ratio of the first and the second display objects on the touch-sensitive display in accordance with a further user input to the touch-sensitive display.

12. A method, comprising:
displaying display data providing information regarding a technical process on a touch-screen as a first display object;
superimposing a second display object on the touch-screen such that the second display object is transparent on the touch-screen with respect to the first display object, whereby the first display object and the second display object are simultaneously visible to a user on the touch-screen; and
updating the first display object while the second display object is superimposed on the first display object and while both the first display object and the second display object are visible to the user.

13. The method according to claim 12, wherein an actuation of the second display object by a user on the touch-screen prompts the update of the first display object on the touch-screen.
